(19) United States
(12) Patent Application Publication
(10) Pub. No.: US 2005/0093198 A1
(43) Pub. Date: May 5, 2005

(54) Wet spinning process for aramid polymer containing salts

(76) Inventor: David J. Rodini, Midlothian, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/699,164

(22) Filed: Oct. 31, 2003

(51) Int. Cl. B29C 47/88

(52) U.S. Cl. 264/184; 264/210.8; 264/211.12

(57) ABSTRACT

Wet spinning of a meta-aramid polymer solution having a salt content of at least 3 percent by weight employs a drawing ratio of greater than 1:1 while in contact with a conditioning solution.

### BACKGROUND OF THE INVENTION

The present invention is an improvement of Wet Spinning Process for Aramid Polymer Containing Salts, U.S. Pat. No. 5,667,743 by Tai et. al. This patent discloses a process incorporating a single stage wet draw of meta-aramid fibers produced by wet spinning of high salt content solutions. The present inventors have found that mechanical properties of the fiber made by this process can be further improved.

### SUMMARY OF THE INVENTION

This invention is directed to an improvement in the process disclosed in U.S. Pat. No. 5,667,743 for wet spinning a meta-aramid polymer from a solvent spinning solution containing concentrations of polymer, solvent, water and more than 3 percent by weight (based on the total weight of the solution) salt comprising the steps of:
(a) coagulating the polymer into a fiber in an aqueous coagulation solution containing a mixture of salt and solvent such that the concentration of the solvent is from about 15 to 25 weight percent of the coagulation solution and the concentration of the salt is from about 30 to 45 weight percent of the coagulation solution and wherein the coagulation solution is maintained at a temperature from about 90 to 125 degrees Celsius;
(b) removing the fiber from the coagulation solution and contacting it with an aqueous conditioning solution containing a mixture of solvent and salt such that the concentrations of solvent, salt and water are defined by the area shown in FIG. 1 as bounded by coordinates W, X, Y and Z and wherein the conditioning solution is maintained at a temperature of from about 20° to 60° C.;
(c) drawing the fiber in an aqueous drawing solution having a concentration of solvent of from 10 to 50 percent by weight of the drawing solution and a concentration of salt of from 1 to 15 percent by weight of the drawing solution;
(d) washing the fiber with water; and
(e) drying the fiber;
   wherein the improvement comprises drawing the fiber while in contact with the conditioning solution employed in step (b), the drawing being accomplished by applying a draw ratio greater than 1:1.

### BRIEF DESCRIPTION OF THE DRAWINGS

FIG. 1 illustrates the composition of the conditioning solutions of the present invention, the region bounded by co-ordinates W, X, Y and Z

FIG. 2 illustrates a diagram of the process steps and techniques that may be used in the practice of the present invention.

### DETAILED DESCRIPTION

Since the present invention is an improvement in the process of Tai et al. U.S. Pat. No. 5,667,743, similar wording and a similar disclosure is present herein in comparison to this publication.

The term “wet spinning” as used herein is defined to be a spinning process in which the polymer solution is extruded through a spinneret that is submerged in a liquid coagulation bath. The coagulation bath is generally a nonsolvent for the polymer.

The term hot stretch or hot stretching as used herein defines a process in which the fiber is heated at temperatures near or in excess of the glass transition temperature of the polymer while at the same time the fiber is drawn or stretched. For poly(m-phenylene isophthalamide), for example, the glass transition temperature is about 250° C. of higher. The drawing is typically accomplished by applying tension to the fiber as it moves between rolls traveling at different speeds. In the hot stretch step, fiber is both drawn and crystallized to develop mechanical properties.

Poly(m-phenylene isophthalamide), (MPD-I) and other meta-aramids may be polymerized by several basic processes. For example, those disclosed in U.S. Pat. No. 3,063,966 and U.S. Pat. No. 3,287,324. Polymer solutions formed from these processes may be rich in salt, salt-free or contain low amounts of salt. Polymer solutions described as having low amounts of salt are those solutions that contain no more than 3.0 percent by weight salt. Any of these polymer solutions may be wet spun by the process of the present invention provided that the salt content, either resulting from the polymerization, or from the addition of salt to a salt-free or low salt-containing solution, is at least 3 percent by weight.

Salt content in the spinning solution generally results from the neutralization of by-product acid formed in the polymerization reaction; but salt may also be added to an otherwise salt-free polymer solution to provide the salt concentration necessary for the present process.

Salts that may be used in the present process include chlorides or bromides having cations selected from the group consisting of calcium, lithium, magnesium or aluminum. Calcium chloride or lithium chloride salts are preferred. The salt may be added as the chloride or bromide or produced from the neutralization of by-product acid from the polymerization of the aramid by adding to the polymerization solution oxides or hydroxides of calcium, lithium, magnesium or aluminum. The desired salt concentration may also be achieved by the addition of the halide to a neutralized solution to increase the salt content resulting from neutralization to that desired for spinning. It is possible to use a mixture of salts in the present invention.

The solvent is selected from the group consisting of those solvents which also function as a proton acceptors, for example dimethylforamide (DMF), dimethylacetamide (DMAc), and N-methyl-2-pyrrolidone (NMP). Dimethyl sulfoxide (DMSO) may also be used as a solvent.

The present invention relates to a process for the production of fibers made of aramids containing at least 25 mole percent (with respect to the polymer) of the recurring structural unit having the following formula,
[—CO—R¹—CO—NH—R²—NH—], (I)

The R¹ and/or R² in one molecule can have one and the same meaning, but they can also differ in a molecule within the scope of the definition given.

If R¹ and/or R² stand for any bivalent aromatic radicals whose valence bonds are in the meta-position or in a comparable angled position with respect to each other, then these are mononuclear or polynuclear aromatic hydrocarbon radicals or else heterocyclic-aromatic radicals which can be mononuclear or polynuclear. In the case of heterocyclic-aromatic radicals, these especially have one or two oxygen, nitrogen or sulphur atoms in the aromatic nucleus.

Polynuclear aromatic radicals can be condensed with each other or else be linked to each other via C—C bonds or via bridge groups such as, for instance, —O—, —CH₂—, —S—, —CO— or SO₂—.

Examples of polynuclear aromatic radicals whose valence bonds are in the meta-position or in a comparable angled position with respect to each other are 1,6-naphthylene, 2,7-naphthylene or 3,4′-biphenyldiyl. A preferred example of a mononuclear aromatic radical of this type is 1,3-phenylene.

In particular it is preferred that the directly spinnable polymer solution is produced which, as the fiber-forming substance, contains polymers with at least 25 mole percent (with respect to the polymer) of the above-defined recurring structural unit having Formula I. The directly spinnable polymer solution is produced by reacting diamines having Formula II with dicarboxylic acid dichlorides having Formula III in a solvent:
H₂N—R²—NH₂ (II),
ClOC—R¹—COCl (III),

The preferred meta-aramid polymer is MPD-I or co-polymers containing at least 25 mole percent (with respect to the polymer) MPD-I.

Although numerous combinations of salts and solvents may be successfully used in the polymer spin solutions of the process of the present invention, the combination of calcium chloride and DMAc is most preferred.

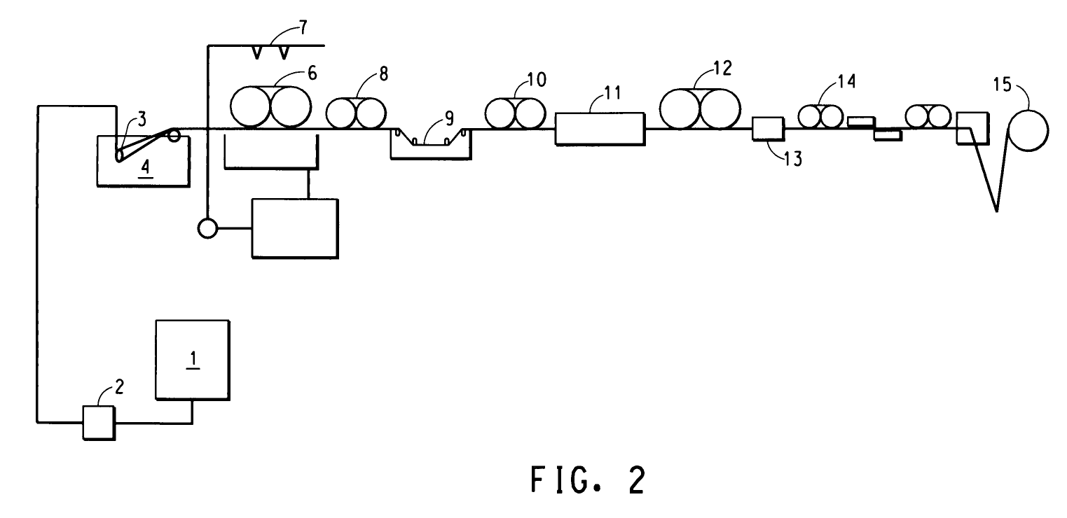

The present process may be used as a continuous process to make fiber. An example of a continuous process is shown in the diagram of FIG. 2. The polymer spinning solution is pumped from a storage tank through a heat exchanger to adjust the polymer temperature and delivered to the inlet of the spin solution metering pump (1). Next the polymer is pumped through the meter pump and through the supply line to the spinneret (3) and finally through the spinneret (4). The spinneret extends below the surface of a coagulation solution which is temperature controlled in the range of from 90 to 125° C. The coagulation solution of the present process will produce fibers that can be successfully conditioned even if the bath is maintained at temperatures that exceed 125° C. Practically, although not theoretically, the coagulation bath temperature is limited to an upper operation temperature of about 135° C. for the DMAc solvent system since at temperatures in excess of 135° C. solvent loss generally exceeds the cost efficiency of solvent replacement and/or recovery. The coagulation solution is housed in a coagulation bath (5) (sometimes called a spin bath). The fiber bundle forms in the coagulation bath and exits the bath on to a first roll (6).

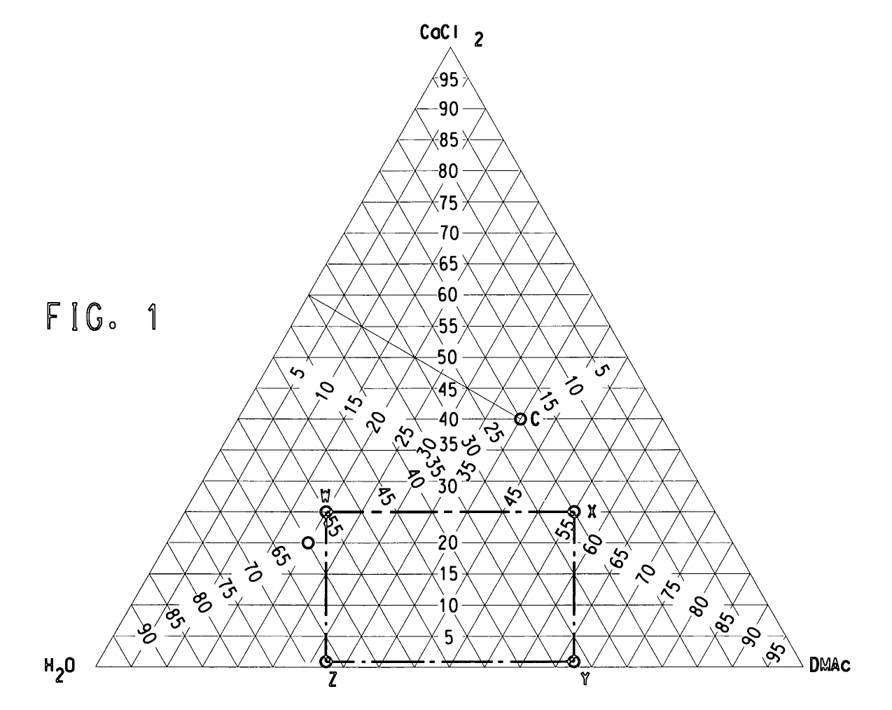

Fiber exiting the coagulation solution is then wet drawn while being contacted by a conditioning solution to maintain the fiber in a plasticized state. It is essential that the concentration of the conditioning solution be within the area defined by the co-ordinates W, X, Y and Z as shown on FIG. 1. These coordinates define combinations of solvent, salt and water that, at the temperatures of 20 to 60° C., will limit diffusion of solvent from the fiber structure and maintain a plasticized polymer fiber. The coordinates: W (20/25/55), X (55/25/20), Y (67/1/32) and Z (32/1/67); are presented as weight percent of the total conditioning solution of solvent/salt/water, respectively. The conditioning solution may typically be applied through the use of a conditioning bath, conditioning spray, jet extraction module, or combination thereof (7), preferability through the use of a jet extraction module. It is of primary importance that the conditioning solution contact each individual filament in the fiber bundle in order for the solution to condition the fibers for proper drawing. The conditioning solution of the present invention maintains the solvent concentration in the fiber so that the fiber is swollen by solvent and is plasticized. The plasticized fiber may then be drawn fully without breaking. Under the tension of drawing any large voids collapse as the polymer is forced into the drawn shape.

The fibers are then drawn, for example, using two sets of rolls (6) and (8) with the application of the conditioning solution conducted in between (7). When the fiber is drawn in this manner, the speeds of the rolls at the entrance to the conditioning draw and at the exit of the conditioning draw are adjusted to give the desired draw ratio. As employed herein “draw ratio” means the ratio of the final to original length per unit weight of yarn. The speed of the rolls is adjusted to achieve a draw ratio greater than 1:1. Although draw ratios above 6:1 can be employed, generally such ratios are less desirable due to a potential for increased fiber damage and/or breakage. A preferred upper limit for draw ratio is 6:1. Preferred ranges are for 3:1 to 6:1 and more preferred 4:1 to 5.5:1.

The present process develops in the coagulation step, the conditioning draw step and optional later drawing steps a fiber that is easily dyeable by conventional aramid dyeing processes. Since no heat treatment other than drying is required to perfect good physical properties, the fiber need never be altered by heating so as to impair its dyeability.

The fiber that is formed by the present process may be wet drawn through conditioning and drawing baths to yield physical properties that are superior to those achieved by conventional dry spinning processes, wet spinning processes that require staged draws and/or hot stretches, or conditioning with a single stage draw as described by Tai in U.S. Pat. No. 5,667,743.

Fiber exiting the conditioning treatment and conditioning draw stage may again be drawn in a subsequent later drawing stage. The fibers may be wet drawn using a drawing solution that contains water, salt and solvent; the solvent concentration is selected so that it is less than the solvent concentration in the conditioning solution. The fibers may be drawn using two sets of rolls (8) and (10) with the fiber being contacted by the drawing solution while between the two sets of rolls (9). The drawing solution may typically be applied through the use of a drawing bath, drawing spray, jet extraction module, or combination thereof (9). The speeds of the rolls at the entrance of the draw bath and at the exit of the draw bath can be adjusted to give the desired draw ratio. Draw ratios as high as 6 have been found to be useful in this process. The concentration range of the drawing solution is by weight percent 10 to 50 percent DMAc preferably 10 to 25 weight percent DMAc. The concentration of salt is preferably no more than 4 percent by weight and can be as high as 15 percent by weight of the drawing solution. There will be salt present in the solution since salt will be removed from the fiber by contact with the drawing solution. Typically, the salt concentration sustained by the process will not exceed 4 percent. If it is desired to increase the salt content above 4 percent, additional salt may be added. The temperature of the drawing solution is maintained from 20 to 80° C.

After all wet drawing is completed the fiber is washed with water in the washing section (11). The method used to wash the fibers is preferably through the use of jet extraction modules however any means or equipment may be used which will remove the solvent and salt from the fiber. After washing, the water content of the fiber may be reduced, for example, by using a set of nip rolls (12) and the fiber may be dried (13) and then processed for end use applications; or, the fiber may be dried and then subjected to additional heat treatment to cause crystallization by passing the fiber through a hot tube, over hot shoes or over heated rolls (14). The fiber is typically dried at about 120 to 125° C. and if desired may be crystallized at much higher temperatures. Crystallization is typically accomplished by passing the fiber between heated rolls at temperatures which are greater than the glass transition temperature of the polymer. For MPD-I, the heat treatment necessary to achieve substantial crystallization requires temperatures equal to or in excess of 250° C. Since the fiber can be drawn prior to crystallization, it is not a requirement of the present process to hot stretch the fiber to develop high tenacity fibers. Thus, heat treatment for crystallation can be achieved with very low or no draw and little additional draw is needed from the exit of the draw bath through the finishing bath (15).

The process of the present invention makes it possible to achieve a variety of fiber shapes, including round, bean or dog-bone. Ribbon shapes may be made using a slotted hole spinneret; trilobal shaped cross sections may be made from a “Y” shaped hole spinneret.

### Test Methods

Inherent Viscosity (IV) is defined by the equation:
IV=ln(hᵣₑₗ)/c
where c is the concentration (0.5 gram of polymer in 100 ml of solvent) of the polymer solution and hᵣₑₗ (relative viscosity) is the ratio between the flow times of the polymer solution and the solvent as measured at 30° C. in a capillary viscometer. The inherent viscosity values are reported and specified herein are determined using DMAc containing 4 percent by weight lithium chloride.

Fiber and yarn physical properties (modulus, tenacity and elongation at break) were measured according to the procedures of ASTM D885. The twist for fibers and yarns was three per inch (1.2 per centimeter) regardless of denier.

Examination of the wet spun fiber cross-section during the different stages of the present process provide insight into fiber morphology. To provide cross sections of a dried fiber, fiber samples were micro-tomed, but since the fibers had not been subjected to drawing or washing special handling was required to ensure that the fiber structure was not unduly influenced during the fiber isolation steps. To preserve the fiber structure during the process of cross sectioning, coagulated or coagulated and conditioned fiber was removed from the process and placed into a solution of similar composition from which it was removed. After about 10 minutes, about one half of the volume of this solution was removed and replaced with an equal volume of water containing about 0.1% by weight of a surfactant. This process of replacing approximately one half of the volume of the solution in which the fiber samples were contained with the surfactized water was continued until nearly all of the original solution had been replaced with surfactized water. The fiber sample was then removed from the liquid and dried in a circulating air oven at about 110° C. The dried fiber was then micro-tomed and examined under the microscope.

In the following examples, all parts and percentages are by weight and degrees in centigrade unless otherwise indicated.

### EXAMPLES

### Example 1

A polymer spinning solution was prepared in a continuous polymerization process by reacting metaphenylene diamine with isophthaloyl chloride. A solution of one part metaphenylene diamine dissolved in 9.71 parts of DMAc was metered through a cooler into a mixer into which 1.88 parts of molten isophthaloyl chloride was simultaneously metered. The mixed was proportioned and the combined flow of the reagents was selected to result in turbulent mixing. The molten isophthaloyl chloride was fed at about 60° C. and the metaphenylene diamine was cooled to about −15° C. The reaction mixture was directly introduced into a jacked, scrapped-wall heat exchanger having a length to diameter ratio of 32 and proportioned to give a hold-up time of about 9 minutes. The heat exchanger effluent flowed continuously to a neutralizer into which was also continuously added 0.311 lb. of calcium hydroxide for each pound of polymer in the reaction solution. The neutralized polymer solution was heated under vacuum to remove water and concentrate the solution. The resulting polymer solution was the polymer spin solution and used in the spinning process described below.

This polymer spin solution had an inherent viscosity of 1.55 as measured in 4.0 percent lithium chloride in DMAc. The polymer concentration in this spinning solution was 19.3 percent by weight. The spin solution also contained 8.9 percent by weight calcium chloride and about 0.5 percent by weight water. The concentration of the DMAc was 71.3 percent by weight.

This solution was placed in a stirred solution tank (1) and heated to approximately 90° C. and then fed by way of a metering pump (2) and filter through 3 spinnerets (3) each having 20000 holes of 50.8 microns (2 mils) diameter. The spinning solution was extruded directly into a coagulation solution that contained by weight 18 percent DMAc, 40 percent calcium chloride and 42 percent water. The coagulation solution (4) was maintained at about 118° C.

The fiber bundle exiting the coagulation solution was wound on roll set (6) having a speed of (20.5 ft/m). A conditioning solution containing by weight 53.5 percent DMAc, 2.2 percent calcium chloride and 44.3 percent water was contacted with the fiber bundle wetting each individual filament as the fiber bundle was wound from roll set (6) to roll set (8) at a speed of (82.0 ft/m). The difference in roll speeds yielded a draw ratio of (4.0). The conditioning solution was at 40° C.

The fiber bundle exiting roll set (8) was contacted by a drawing solution containing by weight 21 percent DMAc, 2 percent calcium chloride and 77 percent water wetting each individual filament of the fiber bundle. The fiber bundle was then wound on roll set (10) at a speed of (82.0 ft/m) to yield a draw ratio in the wet draw zone draw of (1.0).

After the wet draw the filaments were fed into a washing section where the fiber was washed with water at 70° C. The washing section consisted of 5 jet extractor modules. The washed fiber was wound on a roll set (12) at the same speed as the roll set (10). There was no additional drawing or stretching applied to the fiber for the remainder of the process.

Following the water wash, the fiber was dried at 125° C. The fibers had good textile properties even without being subjected to a hot stretching or a crystallization step. The physical properties of this fiber were: denier, (2 dpf), tenacity of (5.0 gpd), elongation of 38.1 percent, modulus of (73.7 gpd).

### Examples 2 Through 6

The fiber was wet spun as described in Example 1. The concentrations of DMAc, CaCl2, and water in the coagulation solution ranged between 17.7 to 18 weight percent, 39.5 to 40.7 weight percent and 41.3 to 42.8 weight percent respectively. The concentrations of DMAc, CaCl2, and water in the conditioning solution ranged between 53.5 to 53.7 weight percent, 2.2 to 3.5, and 43.0 to 44.3 weight percent respectively. The concentrations of DMAc, CaCl₂, and water in the drawing solution ranged between 20.8 to 21.3 weight percent, 2.0 to 2.4 weight percent, and 76.3 to 77.1 weight percent respectively. The roll speeds and draw ratios applied in the conditioning zone draw and draw zone draw are shown in Tables I and Ia. The speed of the rolls is given in feet per minute (ft/m). The properties of the resulting fibers are shown in Table II. The steps and various rolls used in the continuous process are identified in FIG. 2 and in the Detailed Description of the Invention above.

### Example A

Example A is a comparison wherein no draw is applied during the conditioning step.

The fiber was wet spun as described in Example 1. The concentration of the coagulation solution was 18 weight percent DMAc, 40 weight percent CaCl₂, and 42 weight percent water. The concentration of the conditioning solution was 53.6 weight percent DMAc, 3.4 weight percent CaCl₂, and 43 weight percent water. The concentration of the drawing solution was 21 weight percent DMAc, 2.3 weight percent CaCl₂, and 76.7 weight percent water. The speeds of the rolls and the associated draw ratios are shown in Tables I and Ia. The speed of the rolls is given in feet per minute (ft/m). The properties of the resulting fibers are shown in Table II. The steps and various rolls used in the continuous process are identified in FIG. 2 in accordance with a mode of operation previously set forth.

TABLE I
Conditioning Liquid Draw Ratio

| | Roll Speed | Roll Speed | Conditioning Zone |
|---|---|---|---|
| Sample # | (6)(ft/min) | (8)(ft/min) | Draw Ratio |
| 1 | 20.53 | 81.98 | 3.99:1 |
| 2 | 20.55 | 71.94 | 3.5:1 |
| 3 | 20.54 | 61.66 | 3:1 |
| 4 | 20.44 | 51.25 | 2.51:1 |
| 5 | 20.51 | 41 | 2:1 |
| 6 | 20.47 | 30.73 | 1.5:1 |
| A | 20.51 | 20.49 | 1:1 |

TABLE Ia
Draw Zone Draw

| | Roll Speed | Roll Speed | Draw Zone |
|---|---|---|---|
| Sample # | (8)(ft/min) | (10)(ft/min) | Draw Ratio |
| 1 | 81.98 | 81.93 | 1:1 |
| 2 | 71.94 | 81.96 | 1.14:1 |
| 3 | 61.66 | 81.96 | 1.33:1 |
| 4 | 51.25 | 82.0 | 1.6:1 |
| 5 | 41 | 81.99 | 2:1 |
| 6 | 30.73 | 81.98 | 2.67:1 |
| A | 20.49 | 82 | 4:1 |

TABLE II
Fiber Properties

| | | Tenacity | | Modulus | Denier | Toughness | |
|---|---|---|---|---|---|---|---|
| | Total | (Grams | Elongation | (Grams | Per | Tenacity | DMAc |
| Sample | Draw | Per denier) | At Break | Per denier) | Filament | *(Elongation | In Fiber |
| # | Ratio(1) | (gpd)(2) | (%)(2) | (gpd)(2) | (dpf) | At Break)\hat{ }0.5 | (Weight %) |
| 1 | 4.0 | 5.0 | 38.1 | 73.7 | 2 | 30.5 | 0 |
| 2 | 4.0 | 5.6 | 38.4 | 84.8 | 2 | 34.7 | 0 |
| 3 | 4.0 | 5.4 | 41.2 | 73.7 | 2 | 34.6 | 0 |
| 4 | 4.0 | 5.4 | 32.1 | 80.9 | 2 | 30.6 | 0 |
| 5 | 4.0 | 3.9 | 28.6 | 53.3 | 2 | 20.8 | 0 |
| 6 | 4.0 | 4.5 | 27.8 | 75.6 | 2 | 23.6 | 2.7 |
| A | 4.0 | 4.5 | 26.4 | 74.9 | 2 | 23.2 | 2.6 |

(1)The total draw ratio equals the product of the draw ratios of each of the drawing steps.
(2)Measured as per ASTM D885

1. In a process for wet spinning a meta aramid polymer from a solvent spinning solution containing concentrations of polymer, solvent, water and at least 3 percent by weight salt comprising the steps of:
(a) coagulating the polymer into a fiber in an aqueous coagulation solution containing a mixture of salt and solvent such that the concentration of the solvent is from about 15 to 25 weight percent of the coagulation solution and the concentration of the salt is from about 30 to 45 weight percent of the coagulation solution and wherein the coagulation solution is maintained at a temperature from about 90 to 125 degrees Celsius;
(b) removing the fiber from the coagulation solution and contacting it with an aqueous conditioning solution containing a mixture of solvent and salt such that the concentrations of solvent, salt and water are defined by the area shown in FIG. 1 as bounded by coordinates W, X, Y and Z and wherein the conditioning solution is maintained at a temperature of from about 20° to 60° C.;
(c) drawing the fiber in an aqueous drawing solution having a concentration of solvent of from 10 to 50 percent by weight of the drawing solution and a concentration of salt of from 1 to 15 percent by weight of the drawing solution;
(d) washing the fiber with water; and
(e) drying the fiber;
wherein the improvement comprises drawing the fiber while in contact with the conditioning solution of step (b) by applying a draw ratio of greater than 1:1.

2. The process of claim 1 wherein the draw ratio through the conditioning solution is in a range from 3:1 to 6:1.

3. The process of claim 2 wherein the draw ratio through the conditioning solution is in a range from 4:1 to 5.5:1.
